(19) United States
(12) Patent Application Publication
(10) Pub. No.: US 2016/0163178 A1
(43) Pub. Date: Jun. 9, 2016

(54) WATER STORAGE EQUIPMENT AND WATER LEVEL ALARM DEVICE THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LI-XING WU, Shenzhen (CN); SUO-BING SU, New Taipei (TW)

(21) Appl. No.: 14/592,310

(22) Filed: Jan. 8, 2015

(30) Foreign Application Priority Data
Dec. 5, 2014 (CN) 201410731477.7

(51) Int. Cl. G08B 21/18

(52) U.S. Cl. CPC G08B 21/182

(57) ABSTRACT

A water level alarm device includes first and second magnets, a wire, an insulated connection line, a floating body, an amplifier, and an alarm. The wire passes through a gap between the first magnet and the second magnet. The floating body floats in water of water storage equipment. When a water level of the water storage equipment is lower than a reference value, a buoyancy force of the floating body is less than a gravity of the floating body, the floating body pulls the insulated connection line, the insulated connection line vibrates, and the wire vibrates accordingly. The wire cuts magnetic induction lines between a north pole of the first magnet and a south pole of the second magnet to generate induced current. The induced current is amplified by the amplifier and then is output to the alarm, to control the alarm to alarm.

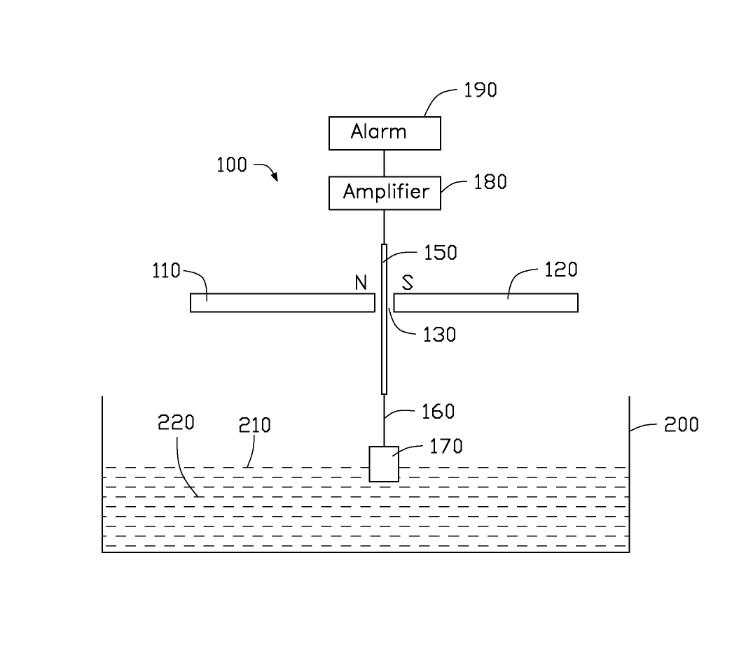

### FIELD

The subject matter herein generally relates to water storage equipment and particularly to water storage equipment with a water level alarm device.

### BACKGROUND

Measuring the water level is important in a wide variety of circumstances. For example, for keeping fish or other aquatic life, the water level of a fish pond must be kept within certain tolerances to keep the aquatic life healthy.

### BRIEF DESCRIPTION OF THE DRAWING

Implementations of the present technology will now be described, by way of example only, with reference to the attached FIGURE.

The FIGURE is a diagram of an embodiment of water storage equipment.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The FIGURE illustrates an embodiment of water storage equipment 200 and a water level alarm device 100 configured to alarm when a water level 210 of the water storage equipment 200 is lower than a reference value. The water level alarm device 100 can comprise a first magnet 110, a second magnet 120, a wire 150, an insulated connection line 160, a floating body 170, an amplifier 180, and an alarm 190.

There is a gap 130 between a north pole N of the first magnet 110 and a south pole S of the second magnet 120. A width of the gap 130 is greater than a diameter of the wire 150; therefore, the wire 150 can pass through the gap 130. A first terminal of the wire 150 is coupled to the floating body 170 through the insulated connection line 160. A second terminal of the wire 150 is electrically coupled to the alarm 190 through the amplifier 180. The floating body 170 floats in water 220 of the water storage equipment 200.

When the water level 210 of the water storage equipment 200 is higher than the reference value, a buoyancy force of the floating body 170 is greater than a gravity of the floating body 170, and the insulated connection line 160 is in a loose state.

When the water level 210 of the water storage equipment 200 is lower than the reference value, the buoyancy force of the floating body 170 is less than the gravity of the floating body 170, the floating body 170 pulls the insulated connection line 160, the insulated connection line 160 vibrates, and the wire 150 vibrates accordingly. When the wire 150 vibrates, the wire 150 cuts magnetic induction lines between the north pole N of the first magnet 110 and the south pole S of the second magnet 120 to generate induced current. One part of the induced current is amplified by the amplifier 180 and then is output to the alarm 190 to control the alarm 190 to alarm. The other part of the induced current stays in the wire 150 to maintain the vibration of the wire 150.

In at least one embodiment, the width of the gap 130 is about 1 millimeter. The wire 150 can be made of silver, copper, gold, aluminum, tungsten, nickel, iron, or other alloy having good electrical conductivity. The insulated connection line 160 can be made of silk, cotton, plastic, or other soft insulating materials. The floating body 170 can be a floating ball or other object which can float in the water. The alarm 190 can be a sound element (such as a buzzer, a speaker, etc.), a light emitting element (such as a light-emitting diode, a liquid crystal display, etc.), or a combination of the sound element and the light emitting element. The water storage equipment 200 can be fish tanks, rivers, reservoirs, and fish ponds, etc.

The embodiment shown and described above is only an example. Many details are often found in the art such as the other features of the water storage equipment. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiment described above may be modified within the scope of the claims.

What is claimed is:

1. A water level alarm device comprising:
an insulated connection line;
an amplifier;
an alarm;
a floating body configured to float in water of water storage equipment;
a first magnet comprising a north pole;
a second magnet comprising a south pole; and
a wire configured to pass through a gap between the north pole of the first magnet and the south pole of the second magnet, the wire comprising a first terminal coupled to the floating body through the insulated connection line, and a second terminal electrically coupled to the alarm through the amplifier;
the water level alarm device configured such that, in response to a water level of the water storage equipment being lower than a reference value, a buoyancy force of the floating body is less than a gravity of the floating body, the floating body pulls the insulated connection line, the insulated connection line vibrates, and the wire vibrates accordingly; and in response to the wire's vibrating, the wire cuts magnetic induction lines between the north pole of the first magnet and the south pole of the second magnet to generate induced current, and the induced current is amplified by the amplifier and then is output to the alarm, to control the alarm to alarm.

2. Water storage equipment comprising:
a water level alarm device comprising:
an insulated connection line;
an amplifier;
an alarm;
a floating body configured to float in water of the water storage equipment;
a first magnet comprising a north pole;
a second magnet comprising a south pole; and
a wire configured to pass through a gap between the north pole of the first magnet and the south pole of the second magnet, the wire comprising a first terminal coupled to the floating body through the insulated connection line, and a second terminal electrically coupled to the alarm through the amplifier;
the water level alarm device configured such that, in response to a water level of the water storage equipment being lower than a reference value, a buoyancy force of the floating body is less than a gravity of the floating body, the floating body pulls the insulated connection line, the insulated connection line vibrates, and the wire vibrates accordingly; and in response to the wire's vibrating, the wire cuts magnetic induction lines between the north pole of the first magnet and the south pole of the second magnet to generate induced current, and the induced current is amplified by the amplifier and then is output to the alarm, to control the alarm to alarm.
